(19) United States
(12) Patent Application Publication
(10) Pub. No.: US 2008/0136703 A1
(43) Pub. Date: Jun. 12, 2008

(54) EQUIVALENT TIME SAMPLING RADAR

(75) Inventor: Naohide Yoshimura, Tokyo (JP)

Correspondence Address: DARBY & DARBY P.C., P.O. BOX 770, Church Street Station, New York, NY, 10008-0770, US

(73) Assignee: Fuji Jukogyo Kabushiki Kaisha, Tokyo (JP)

(21) Appl. No.: 11/948,503

(22) Filed: Nov. 30, 2007

(30) Foreign Application Priority Data
Dec. 8, 2006 (JP) 2006-332006

(51) Int. Cl. G01S 13/00

(52) U.S. Cl. 342/89

(57) ABSTRACT

A transmission side is provided with a power control signal generation section 2 for generating a power control signal whose amplitude is variable in order to equalize a signal intensity of a received signal, and an amplification section 4 for controlling transmission power of a transmission signal of a pulse train, by controlling a gain according to the amplitude of the power control signal.

### CROSS-REFERENCE TO RELATED APPLICATIONS

This application claims priority under 35 U.S.C. 119 based upon Japanese Patent Application Serial No. 2006-332006, filed on Dec. 8, 2006. The entire disclosure of the foresaid application is incorporated herein by reference.

### BACKGROUND OF INVENTION

1. Field of the Invention

The present invention relates to an equivalent time sampling radar.

2. Description of the Related Art

Equivalent time sampling is disclosed in JP-A-01-235863 as a technique for making an attempt to enhance resolution of an object to be detected. A pulse radar using the technique is also proposed. The equivalent time sampling is a method for sampling, at a time offset every cycle, answer-back waves from a target in response to respective transmission pulses in a pulse train and reproducing a waveform of reflected waves, in an extended manner, along a time axis in accordance with the reflected waves of the plurality of pulses. U.S. Pat. No. 5,805,110 discloses a radar searching apparatus which emits a radio wave of constant intensity and subjects a wave reflected from a target to gain control at a receiving side in order to equalize the intensity of a received signal (receiving power) regardless of a distance. Specifically, an STC (Sensitivity Time Control) circuit is provided at a receiving end, and sensitivity is suppressed by decreasing a gain at a short range. Signal intensity is adjusted in such a way that sensitivity is increased with an increase in distance. According to such an STC method, an unwanted reflected wave, such as a clutter, is diminished, and saturation of a received signal may be suppressed by means of rendering receiving intensity constant without regard to a distance. Further, JP-A-2006-064644 discloses a pulse wave radar which performs control operation so as to reduce the degree of amplification of a receiving circuit immediately after transmission of a transmission pulse wave and to increase the degree of amplification of the receiving circuit in association with elapse of a time.

A STC method carries a problem of a relationship between a intensity of a reflected wave and noise (a signal-to-noise ratio) being inconstant with reference to a distance and the signal-to-noise ratio becoming smaller with an increase in distance. When the gain of the receiving side for a long range is increased in order to address such a problem, there arises inconvenience of noise components being also amplified. Since a receiving gain is decreased at a short range, It is difficult to encounter the detection of a small response target.

### SUMMARY OF INVENTION

One or more embodiments of the invention provide a new technique for equalizing a signal intensity of a received signal without regard to a distance.

According to a first aspect of the invention, an equivalent time sampling radar is provided with a controller, at a transmission side, for controlling transmission power according to a sampling time point in order to equalize signal intensity of a received signal.

Further, according to a second aspect of the invention, an equivalent time sampling radar is provided with a power control signal generation section for generating a power control signal whose amplitude is variable to equalize signal intensity of a received signal, an amplification section for controlling transmission power of a transmission signal assuming a form of a pulse train, by a gain controller according to the amplitude of the power control signal, and a transmission antenna for transmitting the transmission signal whose transmission power is controlled by the amplification section.

The amplification section may repeat to increase transmission power nonlinearly by the transition of the sampling time point. The amplitude of the power control signal may be repeatedly increased in a nonlinear manner along a time axis.

The power control signal generation section may synchronize the power control signal to a pulse position modulation signal for sampling the received signal.

According to the embodiments of the present invention, power of the transmission signal is controlled at the transmission side, whereby the signal intensity of the received signal may be equalized without controlling the gain of the received signal at the receiving side.

### BRIEF DESCRIPTION OF THE DRAWINGS

FIG. 1 is a block diagram of an equivalent time sampling radar of an embodiment,

FIG. 2A shows transmission signal of pulse train,

FIG. 2B shows power control signal,

FIG. 2C shows power controlled transmission signal,

FIG. 3A shows sampling performed at slide-offset, time,

FIG. 3B shows expanded received signal,

FIG. 4A shows STC method, and

FIG. 4B shows transmission power control method.

### DETAILED DESCRIPTION

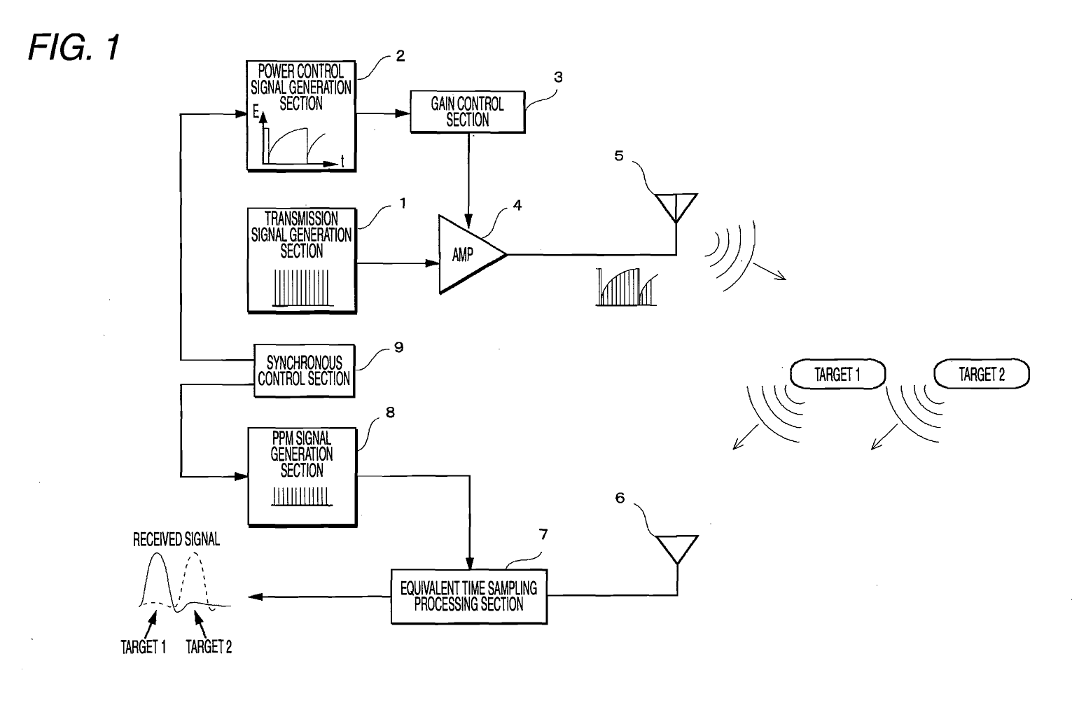

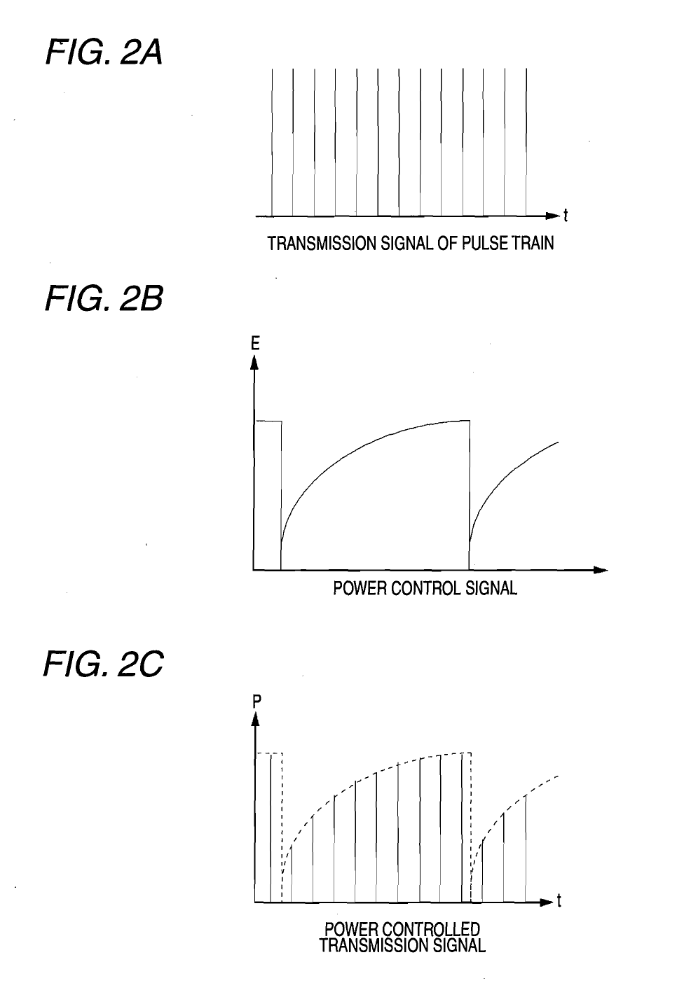

FIG. 1 show a block diagram of an equivalent time sampling radar of an exemplary embodiment of the invention. The radar is provided a principle of pulse-type radar (sensor) that a distance is measured by a time which elapses from when a radio wave is transmitted until when a wave reflected from a target is received. The equivalent time sampling technique is used to especially enhance the resolving of the distance at a short range. The radar is chiefly provided a transmission signal generation section 1, a power control signal generation section 2, a gain control section 3, an amplifier 4, a transmission antenna 5, a receiving antenna 6, an equivalent time sampling processing section 7, and a PPM signal generation section 8. As shown in FIG. 2A, the transmission signal generation section 1 generates a transmission signal of a pulse train in which a pulse (an impulse signal) having a constant amplitude is repeated along the time axis. The power control signal generation section 2 generates a power control signal whose amplitude is variable. As shown in FIG. 2B, the power control signal repeats of a waveform whose amplitude nonlinearly increases along the time axis. Under synchronous control of the synchronous control section 9, the power control signal is synchronized with a pulse position modulation signal (hereinafter called a “PPM signal”) which is used for sampling a received signal. Namely, the power control signal is synchronized with a distance.

In accordance with a power control signal, the gain control section 3 sets a gain in the amplifier 4 responsive to an amplitude of the power control signal. In conjunction with progression of the power control signal along the time axis, the gain also changes over time. The amplifier 4 amplifies a transmission signal output from the transmission signal generation section 1 by the gain set by the gain control section 3. As a result, as shown in FIG. 2C, power of the transmission signal is adjusted and controlled in accordance with a sampling time point. The transmission power controlled signal is transmitted toward targets 1 and 2 by way of a transmission antenna 5.

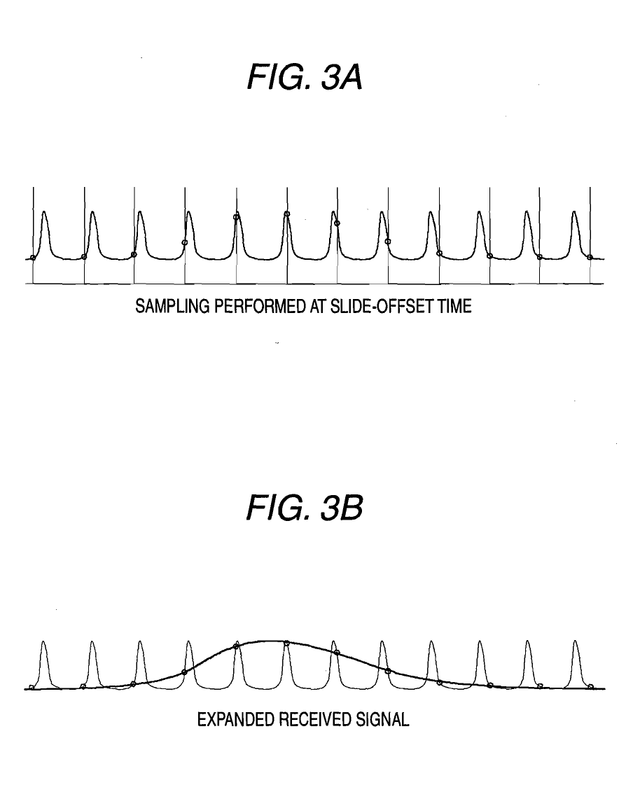

In the meantime, a wave reflected from the target 1 and a wave reflected from the target 2 are received, as received signals, by a receiving antenna 6. In accordance with a PPM signal generated by a PPM signal generated by a PPM signal generation section 8, an equivalent time sampling processing section 7 performs equivalent time sampling by taking the received signal as an input. Equivalent time sampling is processing for converting a short-period recurring signal (i.e., answer-back waves from a target in response to respective transmission pulses) into a long-period recurring signal in order to enhance the resolving of the distance. FIGS. 3A and 3B are descriptive views of equivalent time sampling. As shown in FIG. 3A, the received signal is sampled at a time which has been offset in a sliding manner. The short-period recurring signal is sampled at one point for each period within a given time interval (a frame period). At that time, the respective sampling time points are shifted from a point of recurrence for the recurring signal. Shift processing is called a time scan. As a result, as shown in FIG. 3B, the long-period recurring signal taking the frame period as its period is generated from the waves reflected from the plurality of pulses. The waveform is extended along the time axis. From another viewpoint, offsetting a sampling time point for each period translates into receiving an answer-back signal of a different transmission pulse according to a distance corresponding to the offset time. This is the equivalent of assigning a transmission pulse according to a distance to a target. The STC method—the related-art technique—is for adjusting receiving power at a receiving side while an attention is paid to that point. In contrast, the present embodiment is for controlling transmission power at a transmission side in accordance with a sampling time point which is a distance to the target. A peak for the close target 1 shown in FIG. 1 and another peak for the second target 2 shown in the same drawing become noticeable in the signal output from the equivalent time sampling processing section 7, and these peaks emerge as essentially-identical heights as the same power. Then, distance dependence is reduced.

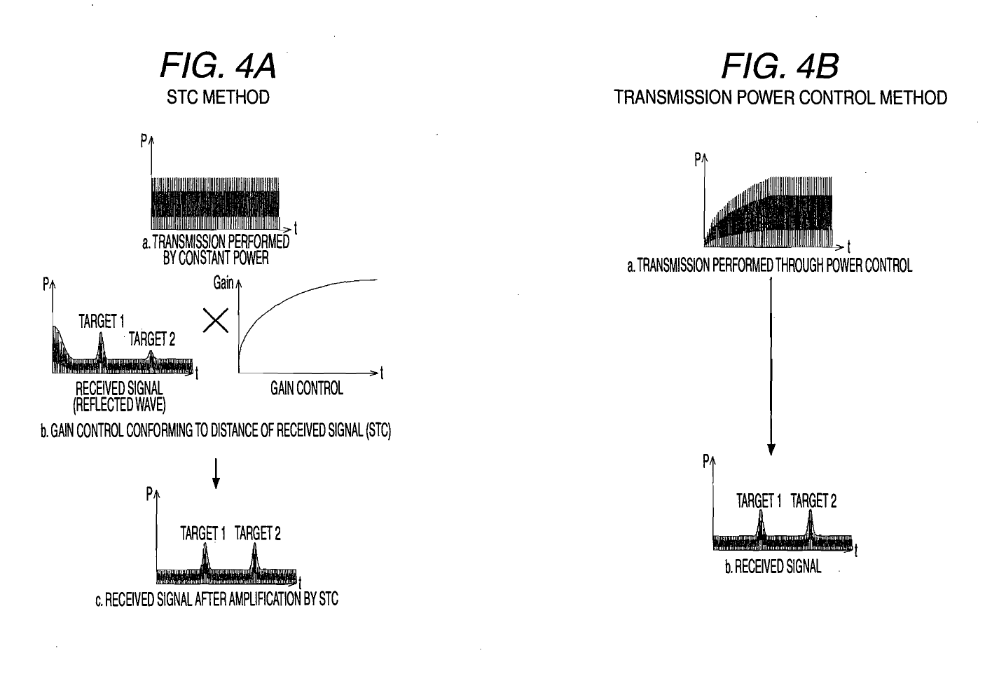

FIGS. 4A and 4B compares descriptive views of the STC method, and transmission power control method which is the related-art. As shown in FIG. 4A, a transmission signal is transmitted at given power according to the STC method. In this case, the intensity of the received signal exhibits distance dependence, and hence, a gain is controlled at the time of amplification of the received signal. Thereby, the received signal whose gain has been controlled is equalized without regard to a distance. The short-range target 1 and the long-range target 2 become noticeable in the form of essentially-analogous peaks. In contrast, as shown in FIG. 4B, according to transmission power control of the present embodiment, a transmission signal whose transmission power has been variably controlled is transmitted in consideration of such distance dependence. As a result, the received signal is effectively equalized without performance of gain control at the receiving side.

As mentioned above, transmission power is controlled at the transmission side according to a sampling time point, thereby equalizing signal intensity of the received signal while resolving the drawback of the STC method that is the related-art. Power Pr of the received signal (a reflected wave) is generally expressed by a radar equation provided below, where Pt designates transmission power; Gt designates a gain of a transmission antenna; σ designates a scattering cross section area of a target located at a distance R; and At designates an effective area of a receiving antenna.

### (Radar Equation)

Pr={(Pt·Gt·Υ)/(4πR²)²}·Ar

According to the equation, the receiving power Pr is inversely proportional to the fourth power of the distance R. Consequently, so long as the radio wave is transmitted at transmission power proportional to the fourth power of a distance, a received signal having constant intensity without regard to a distance. Namely, an equalized, received signal may be obtained. Thus, for example, even when a received signal is subjected directly to A/D conversion, the signal may be digitized by effective use of all bits.

Moreover, the influence of a direct wave may be lessened. In a radar search performed at a short range, a direct wave directly entering the receiving antenna from the transmission antenna is observed. In the case of transmission power conforming to a long-range target, a received signal becomes saturated under the influence of the direct wave, and hence the influence of the direct wave may be reduced.

Further, the influence of a short-range clutter may be lessened. In a radar search performed at a short range, unwanted waves reflected from structures standing in the vicinity of the antenna greatly affect a radar search performed at a short range. In the case of transmission power conforming to a long-range target, a received signal becomes saturated under the influence of the direct wave, and hence the influence of a short-range clutter may be reduced.

The signal-to-noise ratio of the received signal may be equalized. According to the related-art method, even when the received wave is equalized by amplifying a feeble reflected wave from a distance, the signal-to-noise ratio becomes smaller. So long as transmission power is controlled at a transmission side rather than gain is control a receiving side, the signal-to-noise ratio is improved because the degree of amplification of the receiving antenna is constant relative to a distance. Thereby, in a case where a target is determined by use of a certain threshold value in relation to the received signal, an error alarm is maintained constantly without regard to a distance even when the threshold value is rendered constant.

Transmission control complying with an environment becomes possible. Specifically, transmission power may be controlled according to the environment where the radar is used. For example, when an object which will act as an obstacle locates between an antenna and a main target, a transmission gain for a distance from a location where an obstacle locate is increased, thereby preventing occurrence of a decrease in the accuracy of detection of the main target. According to a transmission power control signal conforming to the environment is imparted to a transmission amplifier, thereby the radar search may perform enabling making of flexible, and highly-accurate observations. Moreover, when the radar is used as; for example, an underground radar, the intensity of a wave reflected from a ground surface is extremely stronger than the intensity of a wave reflected from a target in the ground. In such a case, transmission power is reduced for a distance to the ground surface, and the power is increased for a distance which is greater than the distance, thereby the accuracy of detection of the target is enhanced.

What is claimed is:

1. An equivalent time sampling radar comprising:
a controller provided at a transmission side for controlling transmission power according to a sampling time point in order to equalize signal intensity of a received signal.

2. An equivalent time sampling radar comprising:
a power control signal generation section for generating a power control signal whose amplitude is variable, in order to equalize signal intensity of a received signal;
an amplification section for controlling transmission power of a transmission signal of a pulse train, wherein the application section controls a gain according to the amplitude of the power control signal; and
a transmission antenna for transmitting the transmission signal whose transmission power is controlled by the amplification section.

3. The equivalent time sampling radar according to claim 2, wherein the amplification section controls the transmission power so that the transmission power conforming to a long range is larger than the transmission power conforming to a short range.

4. The equivalent time sampling radar according to claim 3, wherein the amplitude of the power control signal is repeatedly increased in a nonlinear manner along a time axis.

5. The equivalent time sampling radar according to claim 2, wherein the power control signal generation section synchronizes the power control signal to a pulse position modulation signal for sampling the received signal.
